(19) United States
(12) Patent Application Publication
(10) Pub. No.: US 2007/0115500 A1
(43) Pub. Date: May 24, 2007

(54) Method for operating communication device

(75) Inventors: Shahana Rahman, Webster, NY (US); Mirelsa Fontanes-Perez, Webster, NY (US); Xin Guo, Penfield, NY (US); Joyce Kay Nakada, Rochester, NY (US)

Correspondence Address: PILLSBURY WINTHROP SHAW PITTMAN, LLP, P.O. BOX 10500, MCLEAN, VA, 22102, US

(73) Assignee: Xerox Corporation, Stamford, CT (US)

(21) Appl. No.: 11/282,699

(22) Filed: Nov. 21, 2005

(51) Int. Cl. G06F 3/12

(52) U.S. Cl. 358/1.15; 358/400

(57) ABSTRACT

A method of operating a communications device comprising: (i) reading a plurality of destination data elements from a medium that is separate from the communication device, and (ii) transmitting data from the communication device to one or more other communication devices corresponding to one or more of the destination data elements.

### FIELD OF THE APPLICATION

The present application relates to communication devices and a method for operating the same.

### BACKGROUND

U.S. patent application Publication No. 2004/0105599-A1 discloses a facsimile transmission machine wherein a destination data element (in the form of a telephone number for a receiving facsimile machine) can be read from a cover page fed into the machine.

### BRIEF SUMMARY

One aspect of the application provides a method of operating a communication device. The device may be of any type, such as a document facsimile transmission machine (i.e., a fax machine), a flatbed scanner, a photocopier machine, or any other device that communicates data from one location to another.

The method comprises reading a plurality of destination data elements from a medium that is separate from the communication device. A destination data element is any data element that instructs the device where data should be transmitted. Non-limiting examples may be a telephone number, an e-mail address or an IP address.

The method also comprises transmitting data from the communication device to one or more other communication devices corresponding to one or more of the destination data elements.

Another aspect of the application provides a communication device comprising a reader for reading a plurality of destination data elements from a medium that is separate from the communication device. The device also comprises a transmitter for transmitting data from the communication device to one or more other communication devices corresponding to one or more of the destination data elements read by the reader.

Other objects, features and advantages of the present application will become apparent based on the following detailed description, the accompanying drawings, and the appended claims.

### BRIEF DESCRIPTION OF THE DRAWINGS

FIG. 1 is a perspective view of a document facsimile device;

FIG. 2 is a cross-sectional view of the device of FIG. 1;

FIG. 3 is a perspective view of another document facsimile device; and

FIG. 4 is a cross-sectional view of the device of FIG. 3.

### DETAILED DESCRIPTION OF THE ILLUSTRATED EMBODIMENTS

In general, the present application is directed to method of operating a communication device. The device may be of any type, such as a document facsimile transmission machine (i.e., a fax machine), a flatbed scanner, a photocopier machine (including digital copiers), or any other device that communicates data from one location to another. In the illustrated embodiment, the device is a document facsimile transmission machine, and thus the invention will be described in the context of such a device. However, the broad principles of the disclosed invention may be practiced with any type of device, including those currently in existence or developed in the future, and no specific references to a facsimile transmission device should be regarded as limiting.

A general description of a document facsimile transmission device is first provided for context.

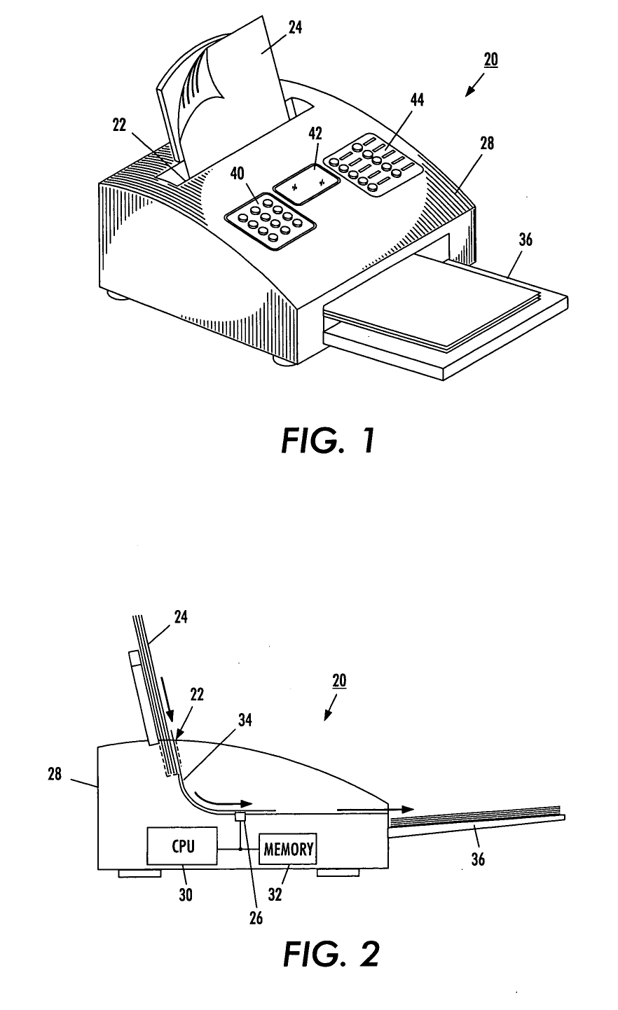

Document facsimile transmission devices are generally well understood. FIGS. 1 and 2 illustrate a document facsimile transmission device 20. The facsimile device receives at a document input 22 a document 24 (or multiple documents) to be scanned and transmitted. The document is usually printed on paper. The device 20 scans the document with a scanner 26 to generate an electronic representation of the document, and transmits the electronic representation of the document to a destination facsimile device (not shown). The transmission process generally includes converting the electronic representation of the document into an analog signal, and transmitting that signal over the telephone system, as is well known.

The device 20 includes a housing 28 that encloses many of the working components, such as the document scanner 26 (FIG. 2), a central processing unit (CPU) 30, and device memory 32. The device 20 may also include a printer element (not shown) and be adapted to receive data from other devices and print images based on that data. A document input 22, such as a document input tray, receives the document 24 to be scanned and transmitted. In operation, the facsimile device 20 draws the document 24 along a paper path 34, past the scanner 26, and to an output tray 36. The scanner 26 scans the document to generate the electronic representation of that document. The facsimile device 20 includes a user interface on the exterior of the housing 28 for providing information to the user, and for the user to instruct the facsimile device 20. The user interface includes a keypad 40 for the user to input information, such as the telephone number of the destination facsimile device. A display screen 42 provides graphical or text information to the user. Other buttons or switches 44 may have specific defined purposes.

The CPU 30 is connected to the scanner 26 to receive at least some of the electronic representations of the documents scanned by the scanner. The scanner may deliver the electronic representation of the documents to the memory 32. Therefore, the CPU 30 may receive the electronic representation of the documents directly from the scanner 26, or from the memory 32. The CPU may be a software controlled general purpose microprocessor. The CPU may also be configured to perform other functions of the facsimile device. In other implementations, the CPU may be a special purpose device for performing the particular tasks described herein, and other control mechanisms may be provided to perform other functions in the facsimile device.

As an alternative to manually inputting the telephone number corresponding to the communication device to which the scanned image data is to be sent, the device 20 may be adapted to read a plurality of telephone numbers (i.e., destination data elements) from a medium that is separate from the device 20. Then, the image data derived from scanning the document would be transmitted from the communication device 20 to one or more other communication devices corresponding to one or more of the read telephone numbers. That is, the device 20 would dial those telephone numbers and transmit the electronic representations of the scanned documents to the devices located at those telephone numbers in a well-known manner. Possibly, instead of telephone numbers, other destination data elements could be input, such as e-mail addresses or IP addresses, and the device 20 could be adapted to transmit to computers located at such addresses. Thus, when reading the destination data elements from a document using optical character recognition, they could be any type of destination data element formed of alphabetical and/or numerical characters.

In the embodiment of FIGS. 1 and 2, the user would feed a document with a list of telephone numbers into the paper path so that the scanner 26 can read the telephone numbers off the document. This may be done before the document(s) to be faxed is scanned in, or after the document(s) to be faxed is scanned in.

In this approach, the scanner 26 would read the telephone numbers from the document with the list using optical character recognition techniques as described in U.S. Patent Publication No. 2004/0105599 A1, the entirety of which is incorporated herein by reference.

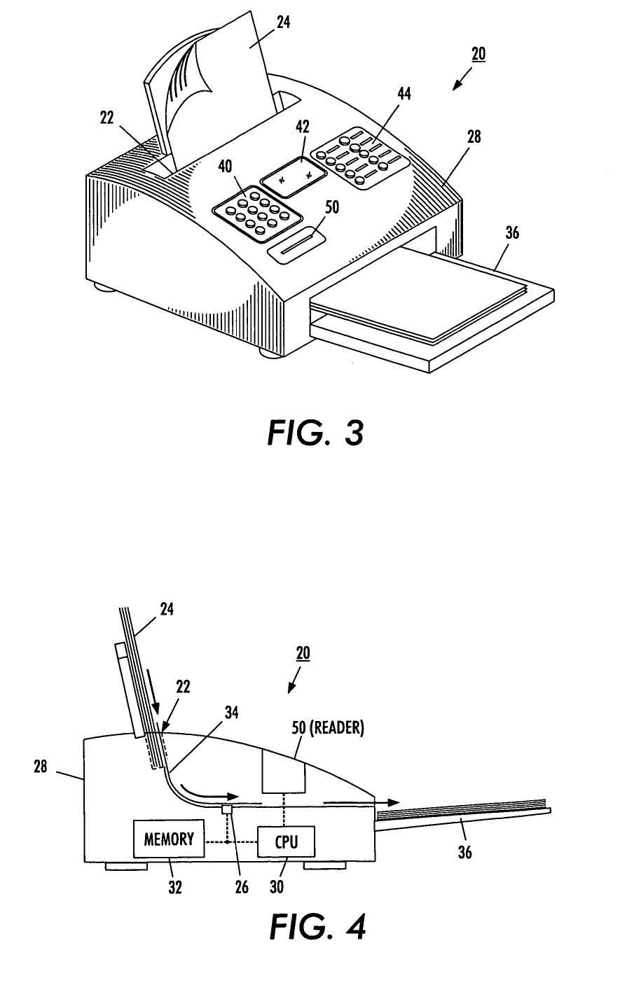

In another approach, as illustrated in FIGS. 3 and 4, the medium may be a machine readable storage medium that contains the destination data elements (e.g., telephone numbers) in computer readable format (i.e., as binary data). Such a medium may be a flash memory, floppy disk, CD, DVD, compact flash, a USB drive or any other such suitable medium that is designed to store data.

In the embodiment of FIGS. 3 and 4, a reader 50 is provided and has a slot opening to the exterior of the housing 28. The same reference numbers are used between the embodiment of FIGS. 1 and 2 and the embodiment of FIGS. 3 and 4 to designate the same structures. The reader 50 removably receives the medium (in this case a compact flash card), and the CPU is adapted to read the destination data elements from the medium. The remainder of the operation would operate much like the embodiment of FIG. 1, where the scanner 26 reads the destination data elements from a document.

When using a machine readable storage medium, an advantageous option is to encrypt the destination data elements. The device 20 would then allow the user to input access information into the device 20 by the user interface to enable the reading of the encrypted destination data elements. Such access information could include, but is not limited to a passcode that is keyed in, or biometric information, such as a fingerprint or retinal scan that is obtained using an appropriate biometric input device (not shown).

As an option, the device 20 may be adapted to enable the user to select one or more of the destination data elements from the plurality thereof. That is, irrespective of how the telephone numbers or other destination data elements are obtained by the device 20, the device 20 may enable the user to select one or more of those from those read or scanned. As such, the data would be thereafter transmitted to the one or more other communication devices corresponding to the one or more destination data elements selected by the user.

To enable the user to select the desired destination data elements, they may be visually displayed on a screen on the communication device 20, such as screen 42, as alphabetical and/or numeric characters. The selecting may be performed by manually operating the user interface. For example, the keypad 40 may be used to scroll through a list of the data elements displayed on the screen 42, and select the one or more desired destination data elements.

The user may also select the desired destination data elements using other arrangements. For example, if a document with a list of destination data elements is being scanned in, the user may circle the selected ones, or mark check boxes next to them. The optical character recognition operation could be adapted to recognize such markings, and read in only those checked or circled (or in accordance with whatever marking is used).

As an optional feature, the device 20 may be adapted to enable the user to store one or more of the read destination data elements in a storage memory in the communication device for later retrieval. Often in devices such as fax machines, the user will be able to store such information in a memory, such as a non-volatile storage memory for later retrieval. The user could use the user interface to effect such storage. Also, as another optional feature, the destination data elements may not be stored in a storage memory in the communication device for later retrieval by a user. With the machine readable storage medium, the device 20 may be adapted to read the destination data elements directly from the medium, thus avoiding even temporary storage of the information. When the destination data elements are being read from a document, the information may be stored temporarily, such as in a volatile memory, so that they cannot be later retrieved.

The ability to provide a list of destination data elements on a medium that is separate from the communication device may have various advantages. For example, if a user often send personal documents from work to a number of different locations, the user may have the desired destination data elements read from the medium without having to input them into the memory of the device. This avoids the need for the user to store the destination data elements (and other identifying data such as the recipient names) into a device that is shared by co-workers. The same advantage may be appreciated in commercially sensitive areas or governmentally classified work where it is not desirable to have telephone numbers or other destination data elements stored in a device shared or accessible by others. Likewise, where the user wants to broadcast a transmission to wide variety of recipients, instead of either entering the destination data elements for each and every recipient or retrieving it from a storage memory in the device 20, the user can simply have the list read from the medium. The user may or may not desire to select certain destination data elements from the list.

These advantages are not intended to be limiting, and are merely reference possible advantages that one may appreciate. The invention may be broadly used for other purposes that achieve some, none, or all of the advantages.

Any patents and/or applications mentioned herein are incorporated into the present application in their entirety for all purposes.

The foregoing detailed description has been provided solely for the purpose of illustrating one or more exemplary embodiments of the invention, and is not intended to be limiting. To the contrary, the present invention is intended to encompass all modifications, substitutions, alterations, and equivalents within the spirit and scope of the following claims.

What is claimed is:

1. A method of operating a communication device, the method comprising:
reading a plurality of destination data elements from a medium that is separate from the communication device; and
transmitting data from the communication device to one or more other communication devices corresponding to one or more of the destination data elements.

2. A method according to claim 1, further comprising storing the destination data elements in a storage memory in the communication device for later retrieval by a user.

3. A method according to claim 1, wherein the destination data elements are not stored in a storage memory in the communication device for later retrieval by a user.

4. A method according to claim 1, further comprising selecting one or more of the destination data elements from the plurality thereof, and wherein the data is transmitted to the one or more other communication devices corresponding to the one or more selected destination data elements.

5. A method according to claim 4, further comprising visually displaying on a screen on the communication device presentations of the destination data elements in alphabetical and/or numeric characters.

6. A method according to claim 4, wherein the selecting is performed by manually operating a user interface on the communication device.

7. A method according to claim 1, wherein the medium is a machine readable storage medium.

8. A method according to claim 7, wherein the destination data elements are encrypted, and wherein the method comprises inputting access information into the communication device to enable the reading of the destination data elements.

9. A method according to claim 8, wherein the access information is a passcode.

10. A method according to claim 1, wherein the medium is a document with the destination data elements provided on a surface thereof.

11. A method according to claim 10, wherein the destination data elements are formed of alphabetical and/or numerical characters, and wherein reading the plurality of destination data elements includes optical character recognition of said characters.

12. A method according to claim 1, wherein the destination data elements are selected from the group consisting of (i) telephone numbers, (ii) electronic mail addresses, and (iii) IP addresses.

13. A method according to claim 1, further comprising scanning an image from a document, and wherein the data transmitted is representative of the scanned image.

14. A method according to claim 13, wherein the communication device is selected from the group consisting of (i) a facsimile machine, (ii) a flatbed scanner, and (iii) a photocopy machine.

15. A communication device comprising:
a reader for reading a plurality of destination data elements from a medium that is separate from the communication device; and
a transmitter for transmitting data from the communication device to one or more other communication devices corresponding to one or more of the destination data elements read by the reader.

16. A communication device according to claim 15, further comprising an input device for enabling selection of one or more of the destination data elements, and wherein the transmitter transmits data to the one or more other communication devices corresponding to the one or more selected destination data elements.

17. A communication device according to claim 16, further a user interface adapted to enable a user to select the one or more selected destination data elements.

18. A communication device according to claim 15, wherein reader is selected from the group consisting of (i) an optical reader adapted to read alphabetical and/or numerical characters from a document, and (ii) a device for reading machine readable storage media.

19. A communication device according to claim 15, wherein the reader is also a scanner for scanning an image from a document, and wherein the data transmitted by the transmitter is representative of the scanned image.

20. A communication device according to claim 19, wherein the communication device is selected from the group consisting of (i) a facsimile machine, (ii) a flatbed scanner, and (iii) a photocopy machine.
